(19) United States
(12) Patent Application Publication
(10) Pub. No.: US 2003/0225559 A1
(43) Pub. Date: Dec. 4, 2003

(54) Verification of multi-cycle paths

(76) Inventor: Anup K. Sharma, Sunnyvale, CA (US)

Correspondence Address: Shireen Irani Bacon, SKJERVEN MORRILL MacPHERSON LLP, Suite 300W, 9600 Great Hills Trail, Austin, TX, 78759, US

(21) Appl. No.: 10/157,670

(22) Filed: May 29, 2002

(51) Int. Cl. G06F 17/50

(52) U.S. Cl. 703/16

(57) ABSTRACT

A method and system for simulating and accounting for design changes in an electrical system. The method and system includes identifying devices, identifying paths connecting the devices, determining the cycles of the signals that are transmitted along the paths, and performing a logical simulation on the system. Information is retained as to the logical simulation and compared to subsequent simulation. Unique naming conventions are given to devices and paths. A script file identifies changes for particular paths.

### BACKGROUND OF THE INVENTION

1. Field of the Invention

This invention relates to monitoring and analysis of signals in electronic systems having multi-cycle paths, in particular recognizing and identifying behavior of multi-cycle paths.

2. Description of the Related Art

In the design of electronic systems, systems including board level, application-specific integrated circuits (ASIC), and full-custom integrated circuits, simulation and analysis is performed on the behavior of signals that are transmitted within the system. It is critical to perform an accurate simulation prior to actual hardware integration, or in the case of ASIC design creation of dies and chip fabrication, to assure that the system performs as expected. Additionally, occasions take place where redesign is required and an accurate understanding of present design signal behavior is needed.

Part of design simulation involves static timing analysis on signals. Static timing analysis looks at behavior and values of signals that are transmitted and received within a system. Static timing analysis looks at signal behavior at particular clock cycles, in effect taking a snap shot of signal values at particular times for a set number of clock cycles.

System simulation, in particular static timing analysis, determines signal values that are sent from and received at devices within the system. Specifically, paths in which signals travel are looked at. Source and destination devices in the system can include memory registers or flip-flops (flops).

Clocks provide timing cycles to signals. Signal paths are considered as either single-cycle or multi-cycle. When a path takes more than one clock cycle, the path is a multi-cycle path. For a multi-cycle path, the path requires more than one clock cycle for the data to settle at a destination device. Occurrences of multi-cycle paths become more prevalent with increases in chip frequencies. Specifically, increased processor speeds in chips and increased chip die sizes have facilitated use of multi-cycle paths to stage flops on wider busses within chips. The use of multi-cycle paths can lead to problems in simulation, in particular problems related to timing, min-timing, and logic verification analysis.

Typically chip design and manufacturing programs involve a separate design group and separate analysis/testing group. Chip design groups use simulation and analysis tools such as register transfer language (RTL). Simulation tools include software programs developed by Chrysalis® Corporation (Chrysalis®). RTL is a type of hardware description language (HDL) used in describing the registers of a computer or digital electronic system, and the way in which data is transferred between them. An example of RTL is Verilog®, a language standard developed by the Institute of Electronics and Electrical Engineers (IEEE). RTL is a useful tool to analyze signals, in particular multi-cycle path signals. RTL can be used to describe multi-cycle paths, and allow designers to make a best guess at the values of particular multi-cycle paths. RTL provides notation describing the workings of computers at the register level. RTL describes the contents of registers, transfers between registers, and operations on values in registers. Verilog compiler simulator (VCS), offered by Synopsys® Corporation, is a simulation program that generates an executable file from an RTL program. The executable file is known as a VCS model or a VCS file. The VCS model can then be run to perform logical simulations, or the VCS model can run diagnostics on the RTL model.

In static timing analysis of electronic systems, in particular ASIC chip designs, the multi-cycle path is masked off and identified as a multi-cycle path. Although paths are identified, simulation tools are unable to accurately understand the functionality of the multi-cycle signal. Since timing analysis tools involve looking at signals per one cycle or a particular cycle, the true functionality of signals in the system can not be determined using conventional timing analysis tools. In other words, interrelationship of single-cycle paths and multi-cycle paths needs to be determined for proper signal analysis; however, if signal analysis, in particular timing analysis, is determined at specific instances, the functionality of single-cycle or multi-cycle paths are not properly determined. If analysis is performed at a particular instance, single-cycle path signals likely have reached their destination; however, multi-cycle paths may not have reached their destination, and functionality is undetermined.

Static timing analysis includes measuring timing paths within a circuit measured from register to register (flop to flop). For example, the analysis begins at a Q output of a given register and follows the logic that originates from the Q output. The analysis follows the signal path. Analysis further takes into account propagation through related logic, counting any propagation delay, and follows logic until the input of another flop is reached. Each path from flop output to flop output is considered a logic path. Paths that originate from a particular flop output are considered part of a logic cone or logic tree. When paths take longer than one clock cycle, paths are considered multi-cycle paths.

In performing static timing analysis for a system that includes single-cycle and multi-cycle paths, running RTL, executing various cycle times, printing out logic, and conducting manual review is necessary to adequately understand the functionality of the behavior of the signals in the system. This process is time consuming, and often times an inaccurate approach in performing signal analysis.

### SUMMARY OF THE INVENTION

What is needed and is disclosed herein is an invention that provides for a method and system to allow easier mapping and verification between logic functionality and timing goals of signal paths.

In an embodiment of the invention, devices in an electrical system are identified, paths connecting the devices are determined, and the number of cycles of the signals are determined. Logical relationship is performed using the identified information.

In certain embodiments of the invention, a script file is created that identifies multi-cycle paths and logic changes from prior configurations of the electrical system. The script file can also provide for transmission delay of particular signals and disable signals according to the particular transmission delay.

In other embodiments of the invention, path hierarchy is identified, where path hierarchy relates to signal path cycles.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features and advantages made apparent to those skilled in the art, by referencing the accompanying drawings. The use of the same reference number throughout the figures designates a like or similar element.

FIG. 1 is a block diagram illustrating a subsystem of two flip-flop registers with output signals multiplexed to a single output signal.

FIG. 2 is a block diagram illustrating inputs to and outputs from a multi-cycle script.

FIG. 3 is a flow chart illustrating how a multi-cycle script operates.

FIG. 4A is a block diagram illustrating a multi-cycle path between two flops.

FIG. 4B is a block diagram illustrating a multi-cycle path between two flops with an enable signal.

FIG. 4C is a block diagram illustrating multi-cycle paths from source flops multiplexed to a destination flop.

FIG. 4D is a block diagram illustrating multi-cycle paths with different cycles from source flops multiplexed to a destination flop.

FIG. 4E is a block diagram illustrating multi-cycle paths from source flops multiplexed into a multi-cycle path.

FIG. 4F is a block diagram illustrating a multi-cycle path from a source flop to a megacell.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed but on the contrary, the intention is to cover all modifications, equivalents, and alternatives falling within the scope of the present invention as defined by the appended claims.

### DETAILED DESCRIPTION

The following is intended to provide a detailed description of an example of the invention and should not be taken to be limiting of the invention itself. Rather, any number of variations may fall within the scope of the invention, which is defined in the claims following the description.

Introduction

The present invention provides a method and system for simulating multi-cycle signal behavior in an electrical system by identifying devices and paths connecting devices. Single and multi-cycle signal paths are identified and disabled accordingly when simulation takes place where simulation is based on a particular cycle, the particular cycle not affecting the disabled path or paths.

Device Interrelationship

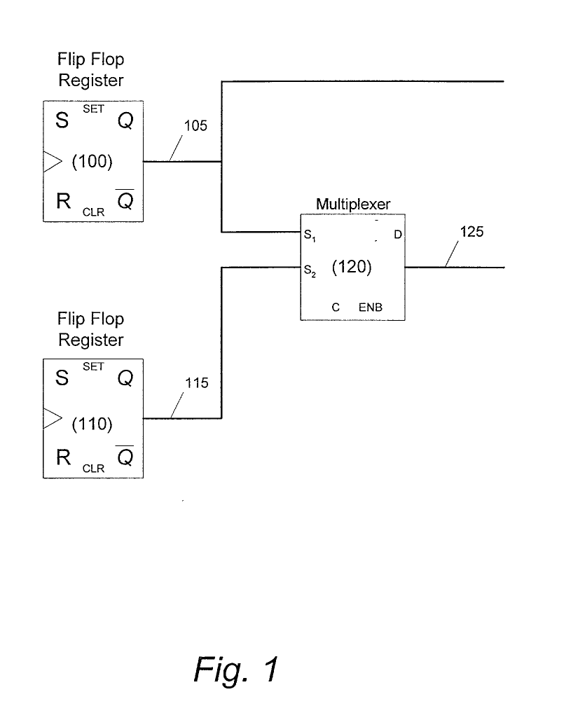

FIG. 1 is a block diagram illustrating a subsystem of two flip-flop registers with output signals multiplexed to a single output signal. Flip-flop register (flop) 100, in this example, transmits a single-cycle signal along path 105. In this particular example, path 105 is split. Multiplexer 120 receives the single-cycle signal transmitted along path 105. Flop 110 transmits a multi-cycle signal along path 115. Multiplexer 120 receives the multi-cycle signal from path 115. Signals transmitted by path 105 and path 115 are processed by multiplexer 120. Multiplexer 120 provides an output signal 125.

When signal analysis is performed, in particular static timing analysis, multiple cycles are not necessarily accounted for. In other words when static timing is performed for the subsystem of FIG. 1 although the single-cycle signal on path 105 has settled and functionality is determined; the multi-cycle signal on path 115 may or may not have settled and functionality may or may not be determined. Therefore, if the number of cycles for the signal on path 115 requires n cycles and timing is performed prior to n cycles, the signal on path 115 has not settled and functionality is undeterminable. If functionality of the signal on path 115 is undeterminable, so is the signal on output path 125 since the signal on path 115 is an input to multiplexer 120.

The example subsystem of FIG. 1 can be part of a larger system, where various subsystems and numerous multi-cycle and single-cycle paths are included. To properly account for the functionality and determine the behavior of all signals, subsystems, and the entire system, static timing analysis must be performed during all cycles from the first cycle to the n^{th} cycle where n is the maximum number of cycles for the system. A determination must be made as to how each signal path functions during each particular cycle. The determination includes the interaction of each signal path with other signal paths during each particular cycle. For relatively small-scale systems this method is acceptable; for large-scale systems this method becomes unduly cumbersome and inaccurate in determining signal functionality and signal/device interrelationship.

Device Naming Convention

A unique name is provided for each device, where a device can be a register, a flop, or a megacell. In particular embodiments of the invention, the unique name can be provided in RTL or Verilog® files. The unique name is given to every device (register) associated with a multi-cycle path or paths. A particular structure of a device naming convention is as follows:

mcM_wNNN_X

The field M is the number of cycles the path is expected to take. The field NNN is a unique number assigned to the path. In practical application, the group or individual responsible for timing analysis (i.e., the analysis/testing group) controls the naming for the unique number. The field X identifies “dst_ff” to designate a destination flop, or identifies “src_ff” to designate a source flop. An example device name that identifies a flop is “jb_ec_data_mc2_w123_src_ff” indicating two (2) cycles that the path is expected to take; “123” is the assigned path number; and in this particular case the flop is a source flop as indicated by “src_ff.”

When an RTL program is run and output is created for verification diagnostics, the script scans the RTL listing for all flops with the previously described naming convention and builds monitors as the RTL program is run. Monitors in turn are used to catch logic problems. A monitor is an RTL program construct that is separate from design, and is part of logical simulation. When a diagnostic test is run on the model, the monitor watches signals in the design and either prints messages in the log file or stops the simulation if an illegal condition occurs. Physical views are generated, while the names of the flops are retained by physical flows. Correct function of the system can be determined with data from the monitor. In particular, a multi-cycle path design can be verified.

An RTL program represents a logical view of a particular design. Before an actual design is sent to be manufactured, an RTL program needs to be translated to physical transistors. This translation is done through the steps of synthesis, and place & route. The steps of synthesis, and place & route, constitute a physical flow. An electronic representation of the end result is a physical view. The physical view is the end result of the design that is to be sent for manufacturing. A net-list is a series of connections that represent how the elements of the physical view are wired together. Net-lists are used to find logical paths in the design and run static timing analysis on these paths. Certain paths, such as fixed values or multi-cycle paths are filtered out of timing reports. Filter files list the paths that are to be excluded from such timing reports. Device gate level net-lists exported and used for timing carry net-list and timing report information. When performing timing analysis, models are built and filter files are compiled for paths before a full chip timing analysis is performed. The filter file is updated for each set of net-list files.

Multi-Cycle Script

When running an RTL program and whenever filter files are compiled, mismatches are identified. For each design change the information is regenerated without manual intervention. A multi-cycle script is generated to automate the process. The script requires the circuit or logic designer to initially define the multi-cycle path in the form of comments in Verilog® files. The script reads the Verilog® files, parses the Verilog® files, and automatically generates a monitor for verification and generates a false path file for timing. Inconsistency between the logic and the monitor files is eliminated since the script is run every time a file is exported into a VCS model.

The multi-cycle script runs in a complete mode and a fast mode. Complete mode generates the monitor file and the false path file. The monitor file is able to work with both RTL and at a device gate level net-lists. When the script is run in complete mode, more information is gathered than in fast mode. In complete mode information is gathered with the use of simulation tools such as Chrysalis®. Complete mode is relatively slow, therefore fast mode is run to increase the speed of operation. In fast mode, only an RTL multi-cycle monitor is generated. Fast mode allows the multi-cycle monitor to be generated when regression is performed.

Example Script File Command

In certain embodiments of the invention, complete mode is a default mode of operation. Fast mode is activated by selecting an option. For example in the following command line, option “-s” selects fast mode when invoking the “mcycle.pl” command. Without “-s” the script runs in complete mode. Option “-f” allows the user to change the “vlist” location; the default “vlist” location is a local directory. A “vlist” is a list of Verilog® files used to build a VCS model. A VCS model is the executable file that a VCS program generates. The VCS model is a representation of an RTL model, in an executable form that can be used to run diagnostics. Option “-d” prints a debug message in a file “debug_file.” Default display is display of the message to the screen. Options “-m” and “-p” provide for each output file to be dumped to a location as specified after the option. Default to local memory is “monitor_result” and “falsepath_result” respectively.

mcycle.pl<-s><-f vlist location><-d debug location><-m monitor_location><-p falsepath location><-h>

When a diagnostic test is run on a VCS model, the multi-cycle monitor watches the signal specified as an n-cycle multi-cycle path. Whenever the signal changes to logical “1” or “0,” the monitor forces a value of “X” on the signal for the period of time for which the signal is deemed to be unusable. Logic simulators such as VCS are limited by logical expressions that evaluate in zero time. This zero time limitation specifically limits the ability and requirement to account for transmission delay of a signal. By providing the value of “X” for a particular signal, the signal is rendered unusable for the amount of time the signal would travel along a particular path in the system. The amount of time translates to transmission delay. “X” indicates an unknown value on a signal—receiving logic may interpret this as “1” or “0.” This forced value, if sampled, would cause the receiving logic to go into an unknown state, causing the diagnostic test to fail.

Use of Script

When system or chip design is performed, logic is designed and multi-cycle path definitions are added as comments in a Verilog® file. The Verilog® file is exported. Complete mode and fast mode can be run during different stages of the design process. Fast mode is run whenever a VCS model is built or imported. Complete mode is run when timing is performed and the most updated false path file, or if gate level simulation is required. RTL files are written as a Verilog® model.

Input and Output Files to Script

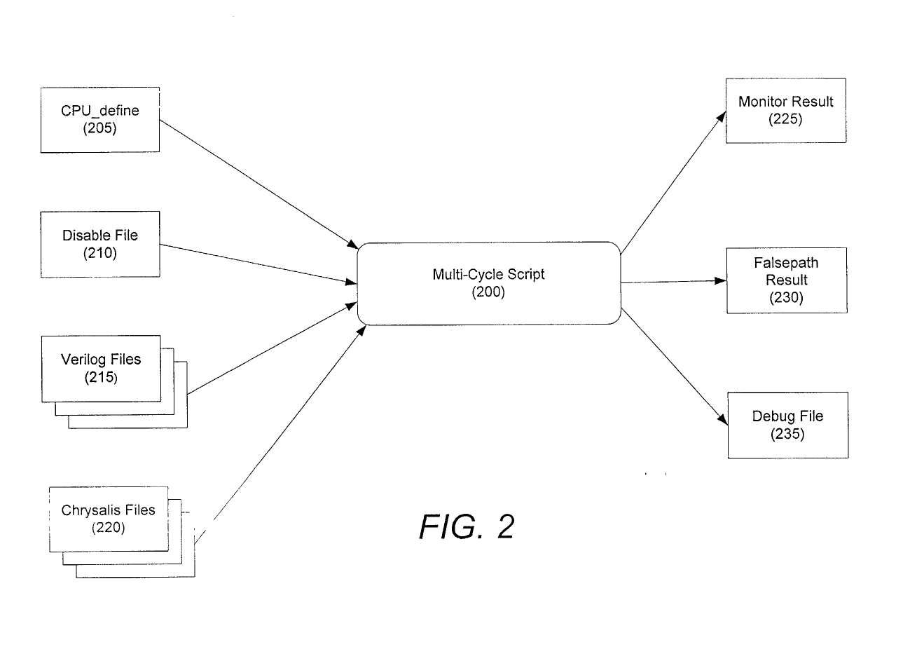

FIG. 2 is a block diagram illustrating inputs to and outputs from a multi-cycle script. In an embodiment of the invention, multi-cycle script 200 requires data in the form of certain files. CPU_define file 205 provides abbreviations for system hierarchy. Disable file 210 allows the chip integrator to disable some multi-cycle paths without modifying multi-cycle comments in Verilog® files 215. Verilog® files 215 allow the script to look for multi-cycle comments and use the multi-cycle comments to build a sense of hierarchy. Verilog® files 215 also avoids having the need to enter hierarchy for every comment. Chrysalis® files 220 are used to file equivalent pins or a bus between RTL and gate level net-lists.

The multi-cycle script 200 provides as outputs the following files: monitor result file 225; false path result path file 230; and debug file 235. Monitor results file 225 is a resulting multi-cycle monitor file. False path result path file 230 is the finished false path file. Debug file 235 is produced when the “-d” option is set when the script is invoked. Debug file 235 contains information for debugging and warnings to the user.

Instruction Command/Comment Line “mcdefine”

Each multi-cycle path is defined as comments in Verilog® files. In a particular embodiment of the invention, the comment format for a multi-cycle path is as follows.

//mcdefine<tagID><hierarchy/ff_name[bus_hi:bus_lo]><mc_cy c><mc_type>[-gate XXX][-mux][-muxsel][-en Hierarchy/Signal]

In this particular embodiment, required and optional items are identified by brackets. Required items are within <> and optional items are within []. Field “tagID” is a unique identifier given to each multi-cycle path. Field “hierarchy” defines where the flop (register) is located starting from the current module, the module where the comment is located. Field “hierarchy” is not needed if the multi-cycle definition is in the same module where the flop is defined. Field “ff_name” is the name of the flop. Field “bus_hi” defines the most significant bit of the bus. Field “bus_lo” defines the least significant bit of the bus. Field “mc_cyc” defines the number of cycles required by the path to travel from source to destination. Field “mc_type” defines the type of pin; the type of pin can be a destination flop (dst_ff) or a source flop (src_ff). Field “-gate” provides the ability to describe explicit gate level description of the same flop and provides an advantage of speeding up the script. Field “-mux” mounts the multi-cycle monitor on all sources with the same “tagID,” and avoids mounting the multi-cycle monitor on the default destination. Field “-muxsel” disables the bus width warning when source and destination have different bus widths. Field “-mux” applies only to destination flops. Field “-en” is an enable signal for a multi-cycle path.

Script Flow

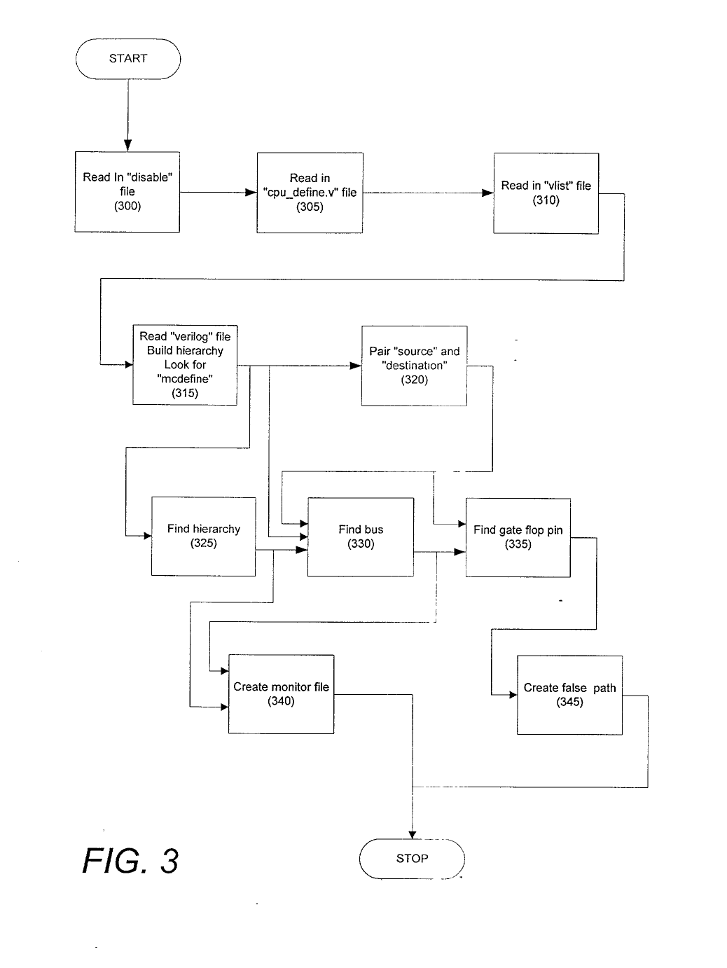

FIG. 3 is a flow chart illustrating how a multi-cycle script operates. A multi-cycle script begins by reading a disable file, step 300. The disable file tracks which multi-cycle path needs to be disabled when false path files and monitor files are generated. The script reads the “cpu_define.v” file, step 305. The “cpu_define.v” file provides abbreviation for some of the modules. The multi-cycle script reads in files such as “vlist” which have Verilog® (or similar) files, step 310. As an example, “vlist” as generated by VCS is read by the multi-cycle script. The Verilog® files are looked at for the following three types of information, step 315: 1) module name of the current module; 2) sub-block instantiated in the current module; and 3) the multi-cycle definition (“mcdefine”).

Source and destination flops are paired with one another based on the unique multi-cycle path tag that is assigned, step 320. Current module and sub-block instantiation are used to determine the hierarchy of the multi-cycle source or destination. Pre-processing steps for each of the source and destination devices or flops are undertaken and hierarchy is found, step 325. Equivalent buses for source and destination devices or flops are found, step 330. Pairing of source and destination devices or flops, step 320, is required before finding equivalent buses, step 330. Within the pre-processing construct, device or flop pins are found, step 335, after source and destination devices or flops are paired, step 335, and equivalent buses are found, step 330. Monitor files can be created, step 340, once step 325 and step 330 are performed. False path files are created, step 345, when step 335 is performed.

Example Multi-Cycle Paths

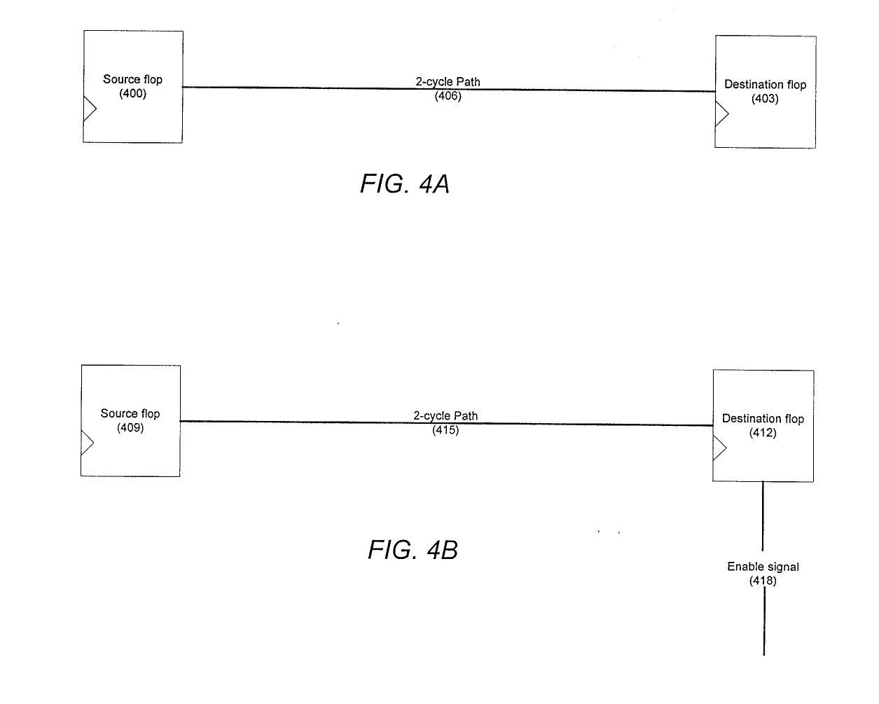

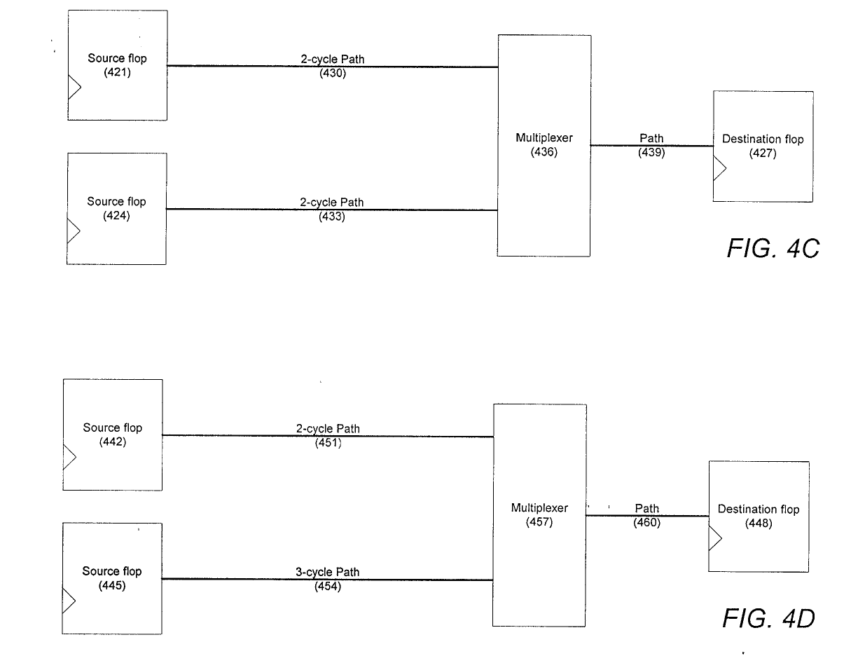

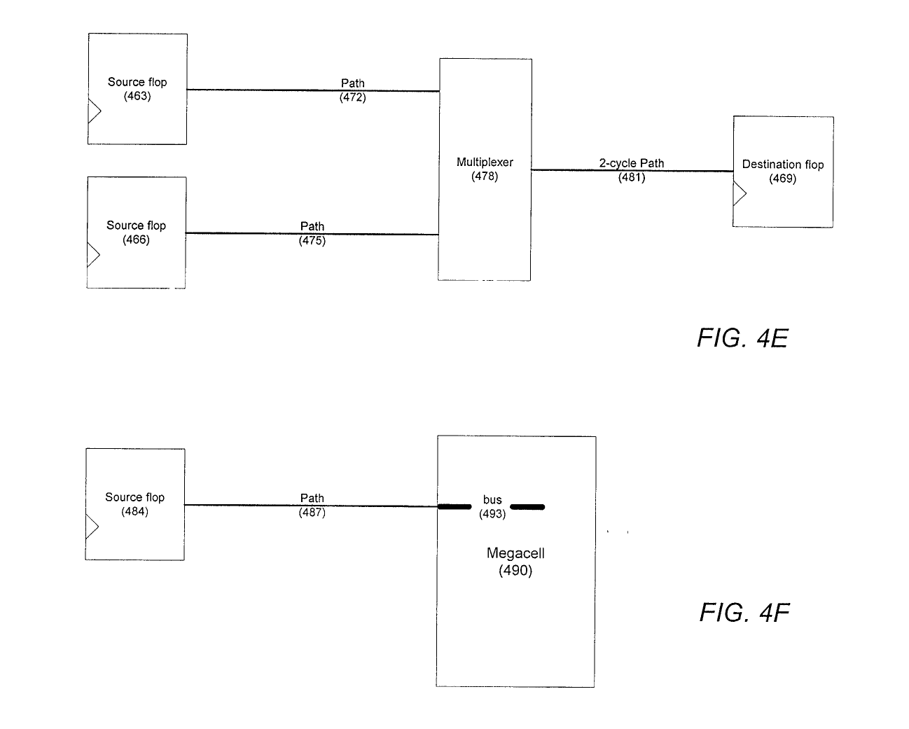

FIG. 4A is a block diagram illustrating a multi-cycle path between two flops. In this example, source flop 400 transmits two-cycle path signal 406 to destination flop 403. Source flop 400 is defined in the source module as:

//mcdefine exp1 src_ffl 2 src_ff

Destination flop 403 is defined in the destination module as:

//mcdefine exp1 dst_ff1 2 dst_ff

FIG. 4B is a block diagram illustrating a multi-cycle path between two flops with an enable signal. In this example, there is one source and one destination. Source flop 409 transmits two-cycle path signal 415 to destination flop 412. Destination flop 412 is activated by enable signal 418. For this example source flop 409 is defined in the source module as:

//mcdefine exp2 src_ff2[1:0] 2 src_ff

Destination flop 412 is defined in the destination module as:

//mcdefine exp2 dst_ff2[1:0] 2 dst_ff -en enable_signal2

FIG. 4C is a block diagram illustrating multi-cycle paths from source flops multiplexed to a destination flop. In this example there are multiple source flops to the same destination with paths from the source flops having the same number of cycles. Source flop 421 and source flop 424 transmit to destination flop 427. Source flop 421 transmits a two-cycle path signal 430, and source flop 424 transmits a two-cycle path signal 433 to a multiplexer 436. Multiplexer 436 in turn transmits a single-cycle path signal 439 to destination flop 427. For this example, source flop 421 is defined in a source module 0 as:

//mcdefine exp3 src0_ff3 2 src_ff

Source flop 424 is defined in a source module 1 as:

//mcdefine exp3 src1_ff3 2 src_ff

Destination flop 427 is defined in the destination module as:

//mcdefine exp3 src0_ff3 2 dst_ff

FIG. 4D is a block diagram illustrating multi-cycle paths with different cycles from source flops multiplexed to a destination flop. Source flop 442 and source flop 445 transmit a signal to destination flop 448. Source flop 442 transmits a two-cycle path signal 451 and source flop 445 transmits a three-cycle path signal 454. Signals 451 and 454 are processed by multiplexer 457. Multiplexer 457 transmits a single-cycle path signal 460 to destination flop 448. For this example, source flop 442 is defined in a source module 0 as:

//mcdefine exp4-1 src0_ff4 2 src_ff

Source flop 424 is defined in a source module 1 as:

//mcdefine exp4-1 src1_ff3 3 src_ff

Destination flop 427 is defined in the destination module as:

//mcdefine exp4-1 dst_ff4 2 dst_ff -mux

//mcdefine exp4-2 dst_ff4 2 dst_ff -mux

When multiple sources lead to multiple destinations, definitions can be separated into cases of multiple sources to one destination.

FIG. 4E is a block diagram illustrating multi-cycle paths from source flops multiplexed into a multi-cycle path. Source 463 and source 466 provide an ultimate signal to destination flop 469. In this particular example, source flop 463 provides a path signal 472 to a select input of multiplexer 478. Source flop 466 provides a path 475 to multiplexer 478. Multiplexer 478 transmits a multi-cycle path signal (two-cycle) 481 to destination flop 469. In the source module, flops 463 and 466 are defined as follows:

//mcdefine exp5 src0_ff5 2 src_ff -muxsel

//mcdefine exp5 src1_ff5[40:0]0 2 src_ff

In the destination module, the destination flop is defined as follows:

//mcdefine exp5 dst_ff5[40:0] 2 dst_ff

FIG. 4F is a block diagram illustrating a multi-cycle path from a source flop to a megacell. One source flop, flop 484, transmits signal path 487 to megacell device 490. In this particular case signal path 487 is received by a pin of megacell device 490. Signal 487 is routed through bus 493 where bus 493 is part of megacell device 490. In the source module, source flop 484 is defined as:

//mcdefine exp6 src1_ff6[40:0] 2 src_ff

For destination megacell 490, the destination module is defined as:

//mcdefine exp6 megacell0/busA[40:0] 2 dst_w

Although the present invention has been described in connection with several embodiments, the invention is not intended to be limited to the specific forms set forth herein, but on the contrary, it is intended to cover such alternatives, modifications, and equivalents as can be reasonably included within the scope of the invention as defined by the appended claims.

What is claimed is:

1. A method of simulating multi-cycle signal behavior in an electrical system comprising:
identifying devices of the system;
associating paths connecting the devices;
determining cycle of signals travelling along the paths; and
determining a logical relationship between the devices.

2. The method of simulating multi-cycle signal behavior of claim 1 wherein the logical relationship between the devices is stored in a file.

3. The method of simulating multi-cycle signal behavior of claim 1 further comprising:
creating a script file where the script file identifies logic changes from a prior configuration of the electrical system.

4. The method of simulating multi-cycle signal behavior of claim 3 wherein the script file provides a transmission delay for the signals travelling along the paths.

5. The method of simulating multi-cycle signal behavior of claim 3 wherein the transmission delay is related to a particular cycle affecting particular paths in the system, and wherein the affected paths are disabled during the determination of logical relationship between devices.

6. The method of simulating multi-cycle signal behavior of claim 5 wherein a predetermined module defines affected paths.

7. The method of simulating multi-cycle signal behavior of claim 5 wherein the paths connecting devices are identified as comments in a simulation file.

8. The method of simulating multi-cycle signal behavior of claim 7 wherein a predetermined module defines affected paths.

9. The method of simulating multi-cycle signal behavior of claim 3 further comprising:
creating a path hierarchy of the system.

10. The method of simulating multi-cycle signal behavior of claim 4 further comprising:
creating a path hierarchy of the system.

11. The method of simulating multi-cycle signal behavior of claim 5 further comprising:
creating a path hierarchy of the system.

12. The method of simulating multi-cycle signal behavior of claim 6 further comprising:
creating a path hierarchy of the system.

13. The method of simulating multi-cycle signal behavior of claim 7 further comprising:
creating a path hierarchy of the system.

14. The method of simulating multi-cycle signal behavior of claim 8 further comprising:
creating a path hierarchy of the system.
